(19) United States
(12) Patent Application Publication
(10) Pub. No.: US 2025/0358640 A1
(43) Pub. Date: Nov. 20, 2025

(54) CELL CLUSTER INTERLEAVING FOR NETWORK SERVICE ACTIVITIES

(71) Applicant: T-Mobile USA, Inc., Bellevue, WA (US)

(72) Inventors: Venu MUDUNURI, Carrollton, TX (US); Jasen VIRASAWMY, Frisco, TX (US); Luis Alberto URIBE GONZALEZ, Parsippany, NJ (US); Robert Andrew BERRIER, Renton, WA (US); Emile Minh TRAN, Sammamish, WA (US); Zia Urrehman KHAN, Sammamish, WA (US); Muhammad Arshad KHADIM, Sammamish, WA (US); Justin R. MUELLER, Sammamish, WA (US)

(21) Appl. No.: 18/664,276

(22) Filed: May 14, 2024

(51) Int. Cl. H04W 24/02; H04W 16/14

(52) U.S. Cl. CPC H04W 24/02; H04W 16/14

(57) ABSTRACT

Cell clusters are interleaved for network service activities, such as frequency retuning and upgrades, so that clusters that are taken offline are interspersed with clusters that remain operational. This minimizes dead zones, in which user equipment (UE) are left entirely without service for the duration of a network service activity. For example, if a cell serving a UE goes out of service for an upgrade, a tier 1 cluster neighbor of that cell remains operational so that the UE may use the neighbor for service. Although the longer distance to the neighbor may result in lower signal quality, many UEs will at least have some connectivity during the network service activity. Examples determine a set of batches for performing a network service activity on radio sites in a geographic region, such that radio sites having overlapping coverage zones are not assigned to the same batch.

### BACKGROUND

Modern cellular networks typically require network service activities relatively often, such as upgrades (software and hardware), maintenance, and configuration changes, including frequency retuning when new spectrum becomes available. Even relatively quick network service activities may take a base station at a radio site (e.g., a cell site or cell cluster) offline for 10 to 30 minutes, during which time the radio site is unable to provide service to user equipment (UEs) in the vicinity. When a network service activity is performed on all or most radio sites in some market (e.g., the cellular coverage for a metropolitan area) UEs may find themselves in the middle of a “dead zone”, entirely without service, for the duration of a network service activity. This adversely affects usability and service reliability for large numbers of UEs.

### SUMMARY

The following summary is provided to illustrate examples disclosed herein, but is not meant to limit all examples to any particular configuration or sequence of operations.

Solutions are disclosed that perform cell cluster interleaving for network service activities. Examples receive a radio site list identifying radio sites associated with an expected network service activity in a geographic region; receive a desired count of batches or a desired maximum count of radio sites per batch; determine a set of batches for performing the network service activity on the radio sites, such that a count of radio sites, having overlapping or adjacent coverage zones within the geographic region and assigned to a common batch identifier (ID), is minimized; and generate a batch list identifying the radio sites and, for each radio site on the batch list, the radio site's assigned batch ID.

### BRIEF DESCRIPTION OF THE DRAWINGS

The disclosed examples are described below with reference to the accompanying drawing figures listed below, wherein:

FIG. 1 illustrates an exemplary architecture that advantageously performs cell cluster interleaving for network service activities;

FIG. 2 illustrates a plurality of cell clusters (generally, radio sites) that may be interleaved for network service activities, as may occur in examples of the architecture of FIG. 1;

FIG. 3 illustrates a central cell cluster and a plurality of tier 1 neighbor cell clusters, among the plurality of cell clusters of FIG. 2;

FIG. 4 illustrates an exemplary graphical depiction of interleaving cell clusters, as may occur in examples of the architecture of FIG. 1;

FIG. 5 illustrates a setting for an interleaving tool that may be used in examples of the architecture of FIG. 1, to produce the interleaving results depicted in of FIG. 4;

FIG. 6 illustrates a timeline of network service activities resulting from using the interleaving tool of FIG. 5;

FIG. 7 illustrates an exemplary user interface (UI) for the interleaving tool of FIGS. 5 and 6;

FIGS. 8 and 9 illustrate flowcharts of exemplary operations associated with the architecture of FIG. 1; and

FIG. 10 illustrates a block diagram of a computing device suitable for implementing various aspects of the disclosure.

Corresponding reference characters indicate corresponding parts throughout the drawings, where practical. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Cell clusters are interleaved for network service activities, such as frequency retuning and upgrades, so that clusters that are taken offline are interspersed with clusters that remain operational. This minimizes dead zones, in which user equipment (UE) are left entirely without service for the duration of a network service activity. For example, if a cell serving a UE goes out of service for an upgrade, a tier 1 cluster neighbor of that cell remains operational so that the UE may use the neighbor for service. Although the longer distance to the neighbor may result in lower signal quality, many UEs will at least have some connectivity during the network service activity. Examples determine a set of batches for performing a network service activity on radio sites in a geographic region, such that radio sites having overlapping coverage zones are not assigned to the same batch.

Aspects of the disclosure thus improve the performance of cellular networks by preventing dead zones, in which UEs are unable to receive service from any cell the duration of a network service activity. This reduces negative impacts on a large number of network users. These advantageous results are accomplished, at least in part by, determining a set of batches for performing a network service activity on radio sites, such that a count of radio sites, having overlapping or adjacent coverage zones within a geographic region and assigned to a common batch identifier (ID), is minimized (or is zero).

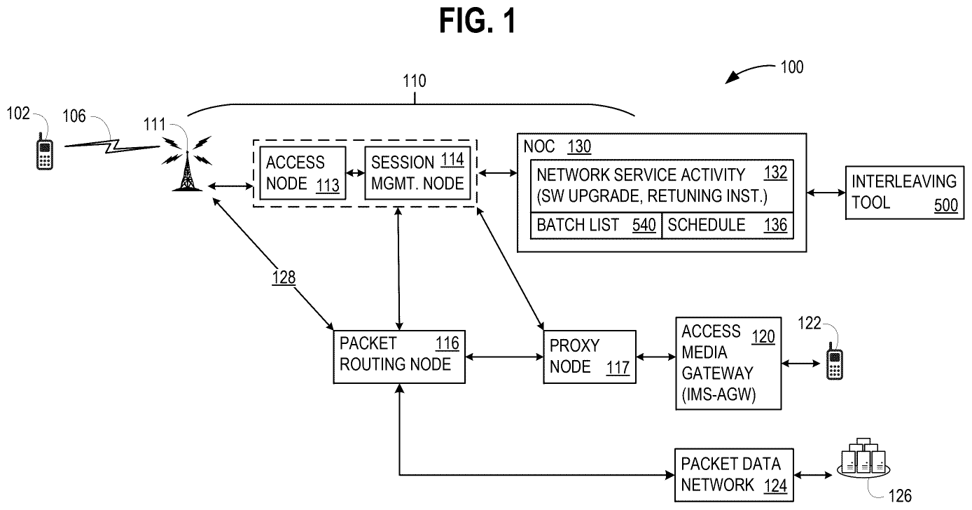

With reference now to the figures, FIG. 1 illustrates an exemplary architecture 100 that advantageously performs cell cluster interleaving for network service activities. A wireless network 110 is illustrated that is serving a UE 102. UE 102 may be an enhanced Mobile Broadband (eMBB) or cellphone, a fixed wireless access (FWA), internet of things (IoT) device, machine-to-machine (M2M) communication device, a personal computer (PC, e.g., desktop, notebook, tablet, etc.) with a cellular modem, or another telecommunication devices capable of using a wireless network. In the scene depicted in FIG. 1, UE 102 is using wireless network 110 for a packet data session to reach a network resource 126 (e.g., a website) across an external packet data network 124 (e.g., the internet). In some scenarios, UE 102 may use wireless network 110 for a phone call with another UE 122. Wireless network 110 may be a cellular network such as a fifth generation (5G) network, a fourth generation (4G) network, or another cellular generation network. In some contexts, 5G is also referred to as new radio (NR), and standalone 5G, which is a full 5G implementation that does not rely on 4G technology for some functionality, may be referred to SA NR.

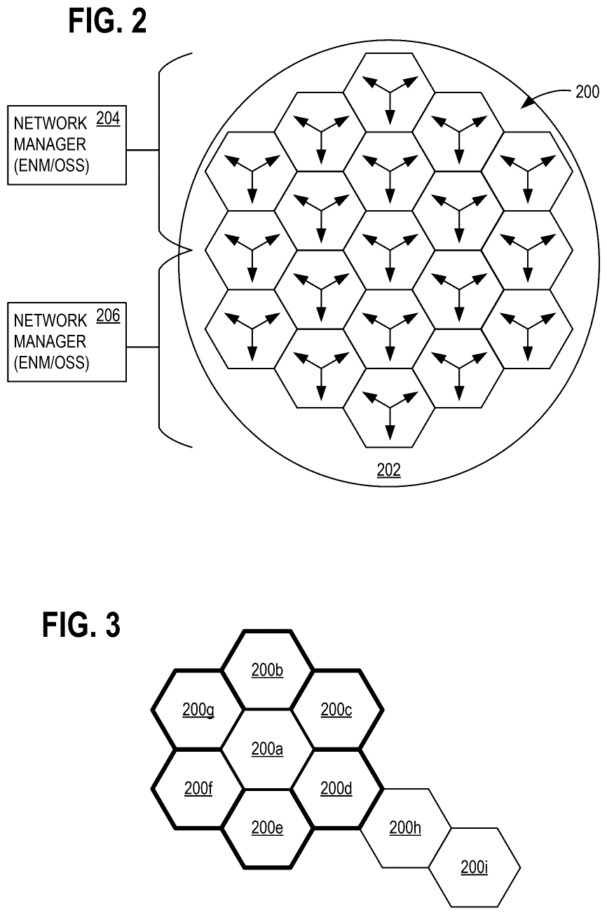

UE 102 uses an air interface 106 to communicate with a base station 111 of wireless network 110, such that base station 111 is the serving base station for UE 102 (providing the serving cell). In some scenarios, base station 111 may be referred to as a radio access network (RAN), and is located at a radio site (See FIG. 2). Wireless network 110 has an access node 113, a session management node 114, and other components (not shown). Wireless network 110 also has a packet routing node 116 and a proxy node 117. Access node 113 and session management node 114 are within a control plane of wireless network 110, and packet routing node 116 is within a data plane (a.k.a. user plane) of wireless network 110.

Base station 111 is in communication with access node 113 and packet routing node 116. Access node 113 is in communication with session management node 114, which is in communication with packet routing node 116 and proxy node 117. Packet routing node 116 is in communication with proxy node 117 and packet data network 124. In some 5G examples, base station 111 comprises a gNodeB (gNB), access node 113 comprises an access mobility function (AMF), session management node 114 comprises a session management function (SMF), and packet routing node 116 comprises a user plane function (UPF).

In some 4G examples, base station 111 comprises an eNodeB (eNB), access node 113 comprises a mobility management entity (MME), session management node 114 comprises a system architecture evolution gateway (SAEGW) control plane (SAEGW-C), and packet routing node 116 comprises an SAEGW-user plane (SAEGW-U). In some examples, proxy node 117 comprises a proxy call session control function (P-CSCF) in both 4G and 5G.

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

Proxy node 117 is in communication with an internet protocol (IP) multimedia system (IMS) access gateway (IMS-AGW) 120 within an IMS, in order to provide connectivity to other wireless (cellular) networks, such as for a call with a UE 122 or a public switched telephone system (PSTN, also known as plain old telephone system, POTS). In some examples, proxy node 117 may be considered to be within the IMS. UE 102 reaches network resource 126 using packet data network 124 (or the IMS, in some examples). Data packets of data traffic 128 to/from UE 102 pass through at least base station 111 and packet routing node 116 on their way from/to packet data network 124 or IMS-AGW 120 (via proxy node 117).

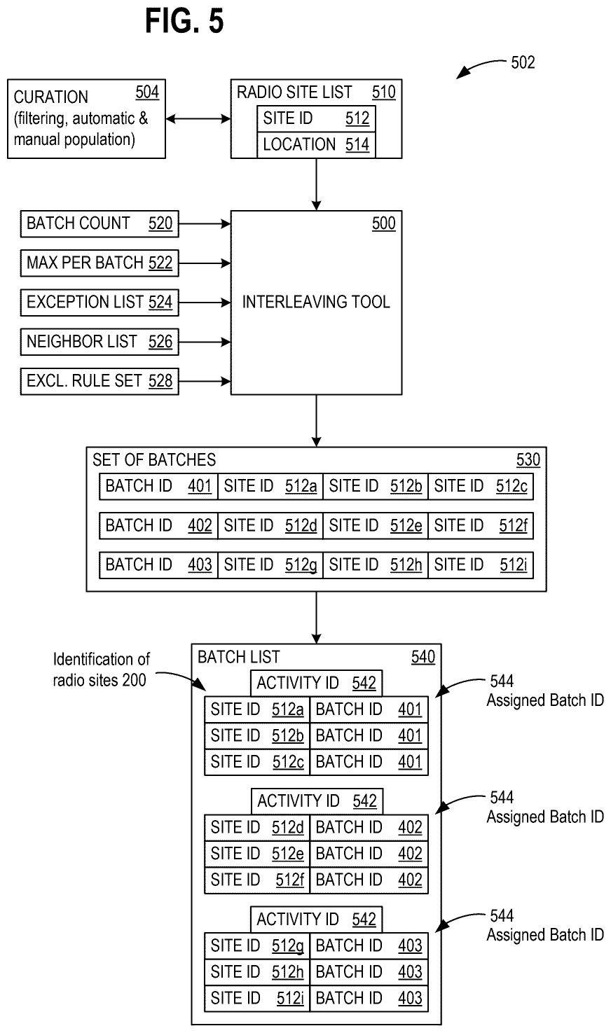

As described more fully below, in relation to the other figures, an interleaving tool 500 schedules a network service activity 132 for nodes of wireless network 110, such as base station 111. Network service activity 132 may be an intangible abstraction in some examples (such as an activity of replacing equipment), but is represented in FIG. 1 as a tangible item such as a software upgrade package or frequency retuning instructions. Wireless network 110 has a network operations center 130 that may be involved in administering network service activity 132, and schedules the various nodes for network service activity 132 according to a batch list 540 (which is shown in further detail in FIG. 5) and a schedule 136.

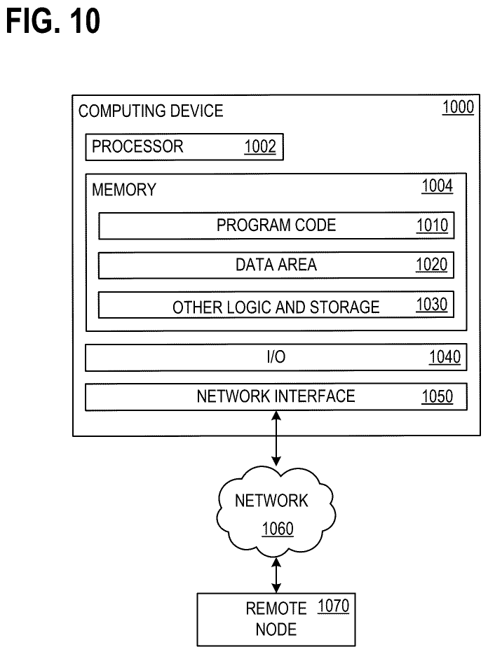

In some examples, interleaving tool 500 is provided as a remote computing service, such as a cloud service, and a user 751 (see FIG. 7), located at network operations center 130, accesses interleaving tool 500 over a computer network 1060 (see FIG. 10). In other examples, interleaving tool 500 may run on a local computing resource. In some examples, batch list 134 may be combined into a single document with schedule 136. Although batch list 134 groups nodes into batches for performing network service activity 132, this alone merely separates into groups. Schedule 136, which further identifies dates and times for the various batches of nodes to undergo network service activity 132, may be generated by interleaving tool 500 and/or user 751.

Although FIG. 1 and some of the following figures are described using an example of a cellular network, it should be understood that the teachings herein are applicable to other types of wireless networks. To benefit from the teachings herein, another type of wireless network should offer geographically-dispersed radio sites with overlapping and/or adjacent coverage, such that a UE being served by one radio site may move over to being served by a neighboring radio site when the initially-serving radio site goes offline for a network service activity. With such a configuration, the teachings herein may extend to the other types of wireless network.

FIG. 2 illustrates radio sites 200 as a plurality of cell clusters that may be interleaved for network service activity 132. Radio sites 200 are the UE-facing portion of wireless network 110 within a geographic region 202, and each radio site of radio sites 200 may contain one or more of base station 111. In the illustrated example, two network managers 204 and 206 provide network management functions for radio sites 200, with network manager 204 handling some and network manager 206 handling the remaining radio sites. In some examples, each of network managers 204 and 206 comprises an external network modifier (ENM) and/or an operational support system (OSS). Performance of network service activity 132 may be limited to radio sites only under the control of one of network managers 204 and 206 at a time, in some scenarios.

FIG. 3 illustrates a definition of tier 1 neighbors, using radio sites 200a-200i of radio sites 200. A central radio site 200a is surrounded by its tier 1 neighbors: a radio site 200b, a radio site 200c, a radio site 200d, a radio site 200e, a radio site 200f, and a radio site 200g—each of which is immediately adjacent to radio site 200a and thus has an adjacent coverage zone. Because radio sites 200b-200g are tier 1 neighbors of radio site 200a, a UE that is being served by radio site 200a may also have sufficient radio channel quality with one (or more) of radio sites 200b-200g to be served by that radio site when radio site 200a goes offline for network service activity 132. This is an overlapping coverage scenario.

Thus, it is desirable that, when radio site 200a is scheduled for performance of network service activity 132, none of radio sites 200b-200g are also scheduled to begin performance of network service activity 132. Instead, performance of performance of network service activity 132 on one or more of radio sites 200b-200g should be contingent on completion of network service activity 132 on radio site 200a, and radio site 200a returning to servicing UEs.

To provide a contrast to clarify the definition of tier 1 neighbor, a radio site 200h and a radio site 200i are not tier 1 neighbors of radio site 200a—although they are tier 1 neighbors of each other. Thus, it is likely acceptable for radio site 200h or radio site 200i (but not both) to be scheduled for performance of network service activity 132 simultaneously with radio site 200a.

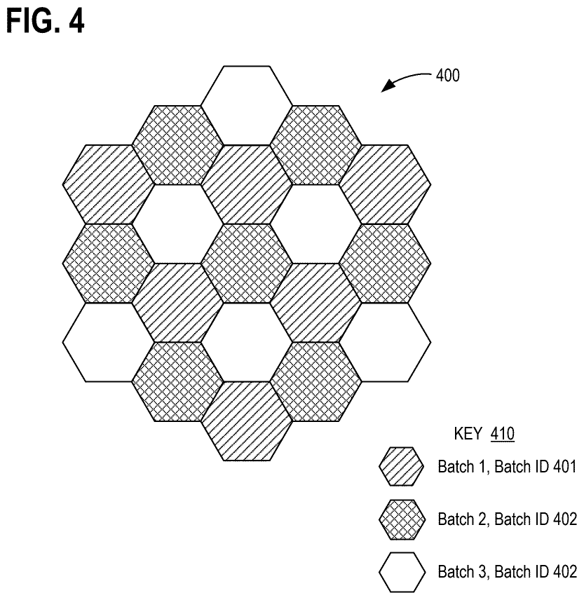

FIG. 4 illustrates an exemplary graphical depiction of interleaving cell clusters. An interspersed set 400 of radio sites 200 is shown with three batches indicated in a key 410. A first batch, with a batch identifier (ID) 401, is shown with diagonal shading, a second batch, with a batch ID 402, is shown with cross-hatch shading, and a third batch, with a batch ID 403, is shown with no shading. No radio sites assigned to batch IDs 401-403 is adjacent to another radio site assigned to the same batch ID. Thus, the count of radio sites, having overlapping or adjacent coverage zones within the geographic region and assigned to a common batch ID, is zero, in this illustrated example.

It may be possible, in some scenarios, with some configurations of radio sites (i.e., complex configurations, rather the simple configuration shown in FIGS. 2-4), if the count of batches is low, that it may be unavoidable that some adjacent radio sites are scheduled for network service activity 132 simultaneously. However, in such scenarios, interleaving tool 500 will minimize the impact, either by minimizing the count of adjacent radio sites, or minimizing the expected number of UEs affected.

FIG. 5 illustrates a setting 502 for use of interleaving tool 500. A radio site list 510 is curated by a curation component 504 that performs filtering and permits manual editing (i.e., additions and removals) of radio sites from radio site list 510, to over-ride automatic population of radio site list 510. For example, some nodes of wireless network 110 may have software or hardware that is incompatible with network service activity 132 (e.g., network service activity 132 is a software upgrade that is incompatible with the operating system of equipment at a particular radio site). Or, there may be operational reasons why certain radio sites are to be omitted from network service activity 132, and a radio site exception list 524 (described below) is not the preferred way to enforce the omission.

As illustrated, radio site list 510 has a radio site ID 512 for each radio site (of radio sites 200) that is included, and also for each site, a radio site physical location 514 which may be geographical coordinates, such as latitude and longitude. In some examples, radio site ID 512 comprises a physical cell identity (PCI). Radio site physical location 514 permits determination of physical distances between radio sites, and determination of which radio sites are neighbors (such as tier 1 neighbors), in the event that a radio site neighbor list 526 (described below) is not provided.

Radio site list 510 is provided to interleaving tool 500, which also accepts other inputs, such as a desired count of batches 520, a desired maximum count of radio sites per batch 522, radio site exception list 524, radio site neighbor list 526, and a neighbor exclusion rule set 528. Some examples may include additional or fewer inputs to interleaving tool 500. Some examples use a user interface (UI) 700, shown in FIG. 7, to provide inputs to interleaving tool 500.

Interleaving tool 500 generates a set of batches 530 in which the number of different batches will typically match desired count of batches 520 (if provided), and for which the number of radio sites assigned to each batch will typically not exceed desired maximum count of radio sites per batch 522 (if provided). Radio site exception list 524 provides a way to exclude certain radio sites from network service activity 132, if such radio sites had not been removed by curation component 504, or to ensure that a particular radio site is excluded in the event that the user is uncertain whether that radio site had been removed. In some scenarios, radio site list 510 may be large enough that manual curation is burdensome and prone to human error.

Radio site neighbor list 526 provides a rapid way to identify tier 1 neighbors and other radio sites having overlapping or adjacent coverage zones, without needing to perform distance calculations using radio site physical locations 514. In some examples, radio site neighbor list 526 provides additional insight into neighbors when long range supercells are used, which may not be determinable using only distance data.

Neighbor exclusion rule set 528 permits more complex rules for determining which pairs of radio sites should not have network service activity 132 performed simultaneously (i.e., be in the same batch), beyond merely no tier 1 neighbors. For example, one of the rules may be that no two radio sites within some distance should be within the same batch. With reference briefly to FIG. 3, if radio sites 200a and 200h are within 2 kilometers (km) of each other, and neighbor exclusion rule set 528 contains a rule that no radio sites within 3 km of each other should be in the same batch, then radio sites 200a and 200h will not be in the same batch-even though they are not tier 1 neighbors of each other.

Other rules may also be used within neighbor exclusion rule set 528. One example may be not permitting two radio sites with actual overlapping coverage to be in the same batch (independent of distance). Such a rule may be useful where supercells are used. An example set of batches 530 is illustrated, with batch IDs 401-403. A radio site ID 512a (a radio site ID 512 for a particular radio site of radio sites 200) is assigned to batch ID 401, along with a radio site ID 512b (a radio site ID 512 for a different particular radio site), and a radio site ID 512c. A radio site ID 512d, a radio site ID 512e, and a radio site ID 512f are assigned to batch ID 402. A radio site ID 512g, a radio site ID 512h, and a radio site ID 512i are assigned to batch ID 403.

A batch list 540 identifies the various ones of radio sites 200 assigned to the various ones of set of batches 530. An activity ID 542 identifies network service activity 132 for site IDs 512a-512c in batch ID 401. Batch ID 402 is the assigned batch ID 544 for site IDs 512a-512c. For site IDs 512d-512f, the assigned batch ID 544 is batch ID 402. For site IDs 512g-512i, the assigned batch ID 544 is batch ID 403. Some examples do not include activity ID 542 in batch list 540. Some examples may further include schedule 136 in batch list 540.

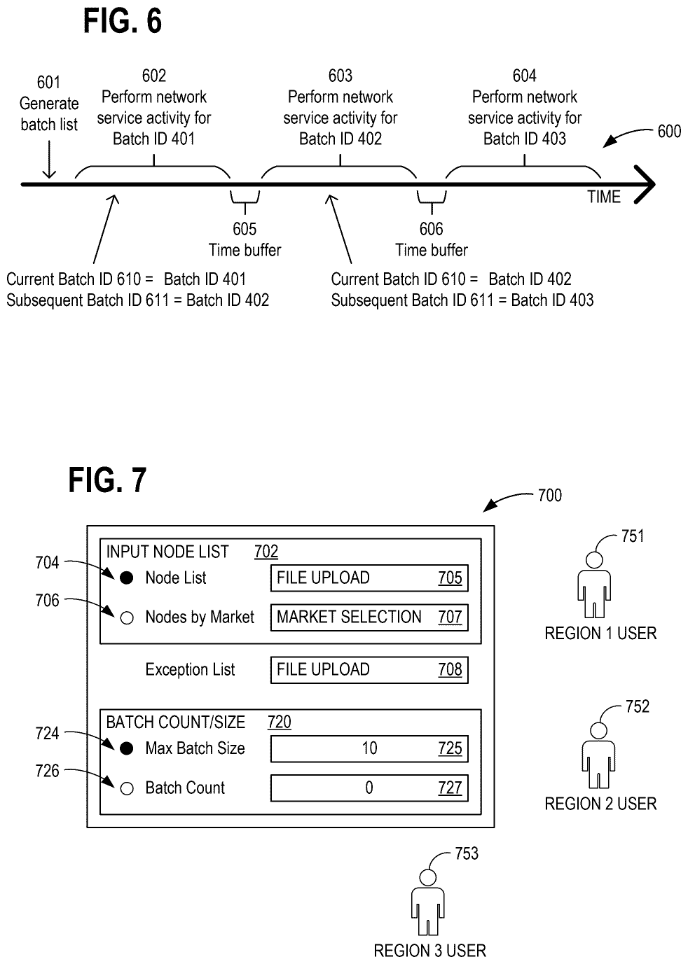

FIG. 6 illustrates a timeline 600 of network service activities resulting from using interleaving tool 500. An event 601 is the generation of batch list 540, and network service activity 132 is performed for radio sites assigned to batch ID 401 during a time period 602. Network service activity 132 is performed for radio sites assigned to batch ID 402 during a time period 603, and network service activity 132 is performed for radio sites assigned to batch ID 403 during a time period 604. A time buffer 605 between time periods 602 and 603, and a time buffer 606 between time periods 603 and 604, provide time to ensure that network service activity 132 has completed for the radio sites in one batch, and those radio sites are back to being operational before the next batch of radio sites is taken offline.

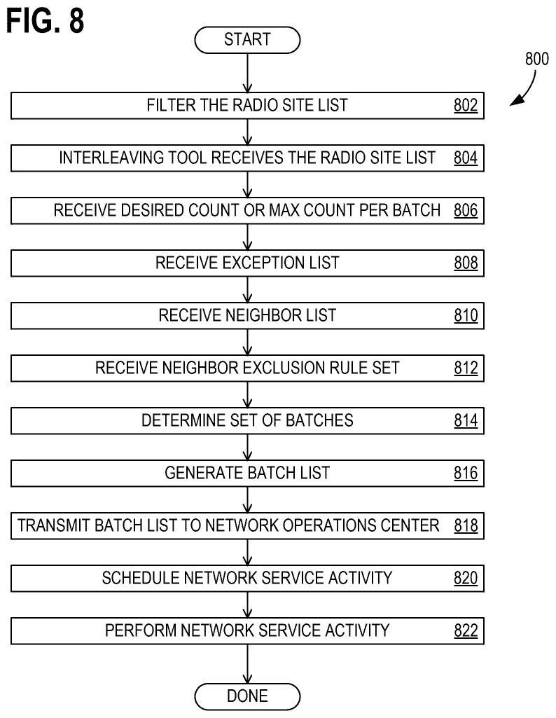

During time period 602, the current batch ID 610 is batch ID 401 and the subsequent batch ID 611 is batch ID 402. During time period 603, the current batch ID 610 is batch ID 402 and the subsequent batch ID 611 is batch ID 403. These designations are defined for use in the description of FIG. 8.

FIG. 7 illustrates UI 700 for interleaving tool 500. A first user 751 uses UI 700 to operate interleaving tool 500 for planning network maintenance in a first geographical region (i.e., a first market) of wireless network 110. Another user 752 uses UI 700 to operate interleaving tool 500 for planning network maintenance in a second geographical region of wireless network 110, and a third user 753 uses UI 700 to operate interleaving tool 500 for planning network maintenance in a third geographical region of wireless network 110. In this way, managers of multiple different regions of a large scale wireless network are each able to independently leverage interleaving tool 500.

UI 700 has an input node list panel 702 that provides a radio button 704 for uploading a radio site list file (e.g., radio site list 510) by further clicking (with a pointer/selection control such as a mouse or touchscreen) on a file upload button 705. Input node list panel 702 also provides a radio button 706 for uploading a radio site list file (e.g., radio site list 510) by further selecting a particular market (geographical region), such as geographical region 202, with selection window 707. For example, selecting geographical region 202 with selection window 707 results in loading radio site list 510. Another file upload button 708 loads radio site exception list 524. Similar controls may load radio site neighbor list 526 and/or neighbor exclusion rule set 528.

UI 700 also has a batch count/size panel 720 that provides a radio button 724 for enabling specification of desired maximum count of radio sites per batch 522 in an edit window 725, and a radio button 726 for enabling specification of desired count of batches 520 in an edit window 727.

FIG. 8 illustrates a flowchart 800 of exemplary operations associated with architecture 100. In some examples, at least a portion of flowchart 800 may be performed using one or more computing devices 1000 of FIG. 10. Flowchart 800 commences with filtering radio site list 510 based on at least each radio site's compatibility with or need for network service activity 132, in operation 802. Network service activity 132 may be any of: frequency retuning, a software upgrade, maintenance, and a hardware upgrade.

In operation 804, interleaving tool 500 receives radio site list 510 identifying radio sites 200 associated with expected network service activity 132 in geographic region 202. Interleaving tool 500 receives further inputs in operations 806-812, such as receiving desired count of batches 520 or desired maximum count of radio sites per batch 522 in operation 806, receiving radio site exception list 524 identifying radio sites to be omitted from set of batches 530 in operation 808, receiving radio site neighbor list 526 identifying each radio site's neighboring radio sites in operation 810, and receiving neighbor exclusion rule set 528 in operation 812. Neighbor exclusion rule set 528 may excludes tier 1 neighbors, neighbors within a minimum distance, and/or neighbors having overlapping coverage from having a common batch ID.

Interleaving tool 500 determines set of batches 530 for performing network service activity 132 on radio sites 200, such that a count of radio sites, having overlapping or adjacent coverage zones within geographic region 202 and assigned to a common batch ID, is minimized in operation 814. In most cases this count will be zero. Some examples of operation 814 use neighbor exclusion rule set 528 to define which radio sites cannot be in the same batch, and some examples further prevent radio sites managed by different network managers from being assigned to a common batch ID.

Batch list 540, identifying radio sites 200 and, for each radio site on batch list 540, the radio site's assigned batch ID 544, is generated by interleaving tool 500 in operation 816. In operation 818, interleaving tool 500 transmits batch list 540 across computer network 1060 to network operations center 130. Network service activity 132 is scheduled according to set of batches 530 in operation 820. For example, network service activity 132 is not scheduled on radio sites assigned to subsequent batch ID 611 until network service activity 132 is completed on radio sites assigned to current batch ID 610.

Network service activity 132 is performed in operation 822 according to set of batches 530. Following schedule 136, network service activity 132 is not performed on radio sites assigned to subsequent batch ID 611 until network service activity 132 is completed on radio sites assigned to current batch ID 610. In some examples, performing network service activity 132 comprises transmitting frequency retuning instructions or a software upgrade to a radio site of radio sites 200.

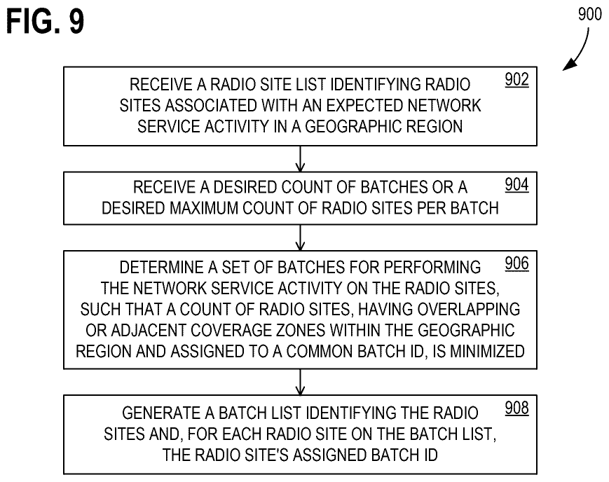

FIG. 9 illustrates a flowchart 900 of exemplary operations associated with examples of architecture 100. In some examples, at least a portion of flowchart 900 may be performed using one or more computing devices 1000 of FIG. 10. Flowchart 900 commences with operation 902, which includes receiving a radio site list identifying radio sites associated with an expected network service activity in a geographic region.

Operation 904 includes receiving a desired count of batches or a desired maximum count of radio sites per batch. Operation 906 includes determining a set of batches for performing the network service activity on the radio sites, such that a count of radio sites, having overlapping or adjacent coverage zones within the geographic region and assigned to a common batch ID, is minimized. Operation 908 includes generating a batch list identifying the radio sites and, for each radio site on the batch list, the radio site's assigned batch ID.

FIG. 10 illustrates a block diagram of computing device 1000 that may be used as any component described herein that may require computational or storage capacity. Computing device 1000 has at least a processor 1002 and a memory 1004 that holds program code 1010, data area 1020, and other logic and storage 1030. Memory 1004 is any device allowing information, such as computer executable instructions and/or other data, to be stored and retrieved. For example, memory 1004 may include one or more random access memory (RAM) modules, flash memory modules, hard disks, solid-state disks, persistent memory devices, and/or optical disks. Program code 1010 comprises computer executable instructions and computer executable components including instructions used to perform operations described herein. Data area 1020 holds data used to perform operations described herein. Memory 1004 also includes other logic and storage 1030 that performs or facilitates other functions disclosed herein or otherwise required of computing device 1000. An input/output (I/O) component 1040 facilitates receiving input from users and other devices and generating displays for users and outputs for other devices. A network interface 1050 permits communication over external computer network 1060 with a remote node 1070, which may represent another implementation of computing device 1000. For example, a remote node 1070 may represent another of the above-noted nodes within architecture 100.

### Additional Examples

An example system comprises: a processor; and a computer-readable medium storing instructions that are operative upon execution by the processor to: receive a radio site list identifying radio sites associated with an expected network service activity in a geographic region; receive a desired count of batches or a desired maximum count of radio sites per batch; determine a set of batches for performing the network service activity on the radio sites, such that a count of radio sites, having overlapping or adjacent coverage zones within the geographic region and assigned to a common batch identifier (ID), is minimized; and generate a batch list identifying the radio sites and, for each radio site on the batch list, the radio site's assigned batch ID.

An example method comprises: receiving a radio site list identifying radio sites associated with an expected network service activity in a geographic region; receiving a desired count of batches or a desired maximum count of radio sites per batch; determining a set of batches for performing the network service activity on the radio sites, such that a count of radio sites, having overlapping or adjacent coverage zones within the geographic region and assigned to a common batch ID, is minimized; and generating a batch list identifying the radio sites and, for each radio site on the batch list, the radio site's assigned batch ID.

One or more example computer storage devices has computer-executable instructions stored thereon, which, upon execution by a computer, cause the computer to perform operations comprising: receiving a desired count of batches or a desired maximum count of radio sites per batch; determining a set of batches for performing the network service activity on the radio sites, such that a count of radio sites, having overlapping or adjacent coverage zones within the geographic region and assigned to a common batch ID, is minimized; and generating a batch list identifying the radio sites and, for each radio site on the batch list, the radio site's assigned batch ID.

Alternatively, or in addition to the other examples described herein, examples include any combination of the following:
the wireless network comprises a cellular network;
performing the network service activity according to the set of batches;
the network service activity is not performed on radio sites assigned to a subsequent batch ID until the network service activity is completed on radio sites assigned to a current batch ID;
the count of radio sites, having overlapping or adjacent coverage zones within the geographic region and assigned to a common batch ID, is zero;
the radio sites comprise cell sites or cell clusters;
the network service activity comprises an activity selected from the list consisting of: frequency retuning, a software upgrade, maintenance, and a hardware upgrade;
the radio site list comprises a radio site ID and a radio site physical location;
receiving a radio site exception list identifying radio sites to be omitted from the set of batches;
filtering the radio site list based on at least each radio site's compatibility with or need for the network service activity;
the wireless network comprises two network managers managing radio sites in the geographic region;
determining the set of batches comprises preventing radio sites managed by different network managers from being assigned to a common batch ID;
the radio site ID comprises a PCI;
the radio site ID comprises a cluster ID and a PCI for each cell in the cell cluster;
the radio site physical location comprises geographical coordinates;
receiving a radio site neighbor list identifying each radio site's neighboring radio sites;
determining the set of batches for performing the network service activity on the radio sites according to a neighbor exclusion rule set;
the neighbor exclusion rule set excludes tier 1 neighbors, neighbors within a minimum distance, and/or neighbors having overlapping coverage from having a common batch ID;
the batch list further identifies the network service activity;
the network managers each comprises an ENM and/or an OSS;
scheduling the network service activity according to the set of batches, wherein the network service activity is not scheduled on radio sites assigned to a subsequent batch ID until the network service activity is completed on radio sites assigned to a current batch ID; and
performing the network service activity comprises transmitting frequency retuning instructions or a software upgrade to a radio site.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of performing maintenance on a wireless network, the method comprising:
receiving a radio site list identifying radio sites associated with an expected network service activity in a geographic region;
receiving a desired count of batches or a desired maximum count of radio sites per batch;
determining a set of batches for performing the network service activity on the radio sites, such that a count of radio sites, having overlapping or adjacent coverage zones within the geographic region and assigned to a common batch identifier (ID), is minimized; and
generating a batch list identifying the radio sites and, for each radio site on the batch list, the radio site's assigned batch ID.

2. The method of claim 1, further comprising:
performing the network service activity according to the set of batches, wherein the network service activity is not performed on radio sites assigned to a subsequent batch ID until the network service activity is completed on radio sites assigned to a current batch ID.

3. The method of claim 1, wherein the count of radio sites, having overlapping or adjacent coverage zones within the geographic region and assigned to a common batch ID, is zero.

4. The method of claim 1, wherein the radio sites comprise cell sites or cell clusters.

5. The method of claim 1, wherein the network service activity comprises an activity selected from the list consisting of:
frequency retuning, a software upgrade, maintenance, and a hardware upgrade.

6. The method of claim 1, wherein the radio site list comprises a radio site ID and a radio site physical location.

7. The method of claim 1, further comprising:
receiving a radio site exception list identifying radio sites to be omitted from the set of batches; or
filtering the radio site list based on at least each radio site's compatibility with or need for the network service activity.

8. The method of claim 1, wherein the wireless network comprises two network managers managing radio sites in the geographic region, and determining the set of batches comprises preventing radio sites managed by different network managers from being assigned to a common batch ID.

9. A system comprising:
a processor; and
a computer-readable medium storing instructions that are operative upon execution by the processor to:
receive a radio site list identifying radio sites associated with an expected network service activity in a geographic region;
receive a desired count of batches or a desired maximum count of radio sites per batch;
determine a set of batches for performing the network service activity on the radio sites, such that a count of radio sites, having overlapping or adjacent coverage zones within the geographic region and assigned to a common batch identifier (ID), is minimized; and
generate a batch list identifying the radio sites and, for each radio site on the batch list, the radio site's assigned batch ID.

10. The system of claim 9, wherein the instructions are further operative to:
schedule the network service activity according to the set of batches, wherein the network service activity is not scheduled on radio sites assigned to a subsequent batch ID until the network service activity is completed on radio sites assigned to a current batch ID.

11. The system of claim 9, wherein the count of radio sites, having overlapping or adjacent coverage zones within the geographic region and assigned to a common batch ID, is zero.

12. The system of claim 9, wherein the network service activity comprises an activity selected from the list consisting of:
frequency retuning, a software upgrade, maintenance, and a hardware upgrade.

13. The system of claim 9, wherein the radio site list comprises a radio site ID and a radio site physical location.

14. The system of claim 9, wherein the instructions are further operative to:
receive a radio site exception list identifying radio sites to be omitted from the set of batches; or
filter the radio site list based on at least each radio site's compatibility with or need for the network service activity.

15. One or more computer storage devices having computer-executable instructions stored thereon, which, upon execution by a computer, cause the computer to perform operations comprising:
receiving a radio site list identifying radio sites associated with an expected network service activity in a geographic region;
receiving a desired count of batches or a desired maximum count of radio sites per batch;
determining a set of batches for performing the network service activity on the radio sites, such that a count of radio sites, having overlapping or adjacent coverage zones within the geographic region and assigned to a common batch identifier (ID), is zero; and
generating a batch list identifying the radio sites and, for each radio site on the batch list, the radio site's assigned batch ID.

16. The one or more computer storage devices of claim 15, wherein the operations further comprise:
scheduling the network service activity according to the set of batches, wherein the network service activity is not scheduled on radio sites assigned to a subsequent batch ID until the network service activity is completed on radio sites assigned to a current batch ID.

17. The one or more computer storage devices of claim 15, wherein the radio sites comprise cell sites or cell clusters.

18. The one or more computer storage devices of claim 15, wherein the network service activity comprises an activity selected from the list consisting of:
frequency retuning, a software upgrade, maintenance, and a hardware upgrade.

19. The one or more computer storage devices of claim 15, wherein the radio site list comprises a radio site ID and a radio site physical location.

20. The one or more computer storage devices of claim 15, wherein the operations further comprise:
receiving a radio site exception list identifying radio sites to be omitted from the set of batches; or
filtering the radio site list based on at least each radio site's compatibility with or need for the network service activity.
